(19) United States
(12) Patent Application Publication
(10) Pub. No.: US 2009/0245736 A1
(43) Pub. Date: Oct. 1, 2009

(54) Connector attachment to a low height profile module

(76) Inventors: Joseph F. Ahadian, San Marcos, CA (US); Charles B. Kuznia, Encinitas, CA (US); Richard T. Hagan, Mission Viejo, CA (US); Richard J. Pommer, Carlsbad, CA (US)

Correspondence Address: THE NATH LAW GROUP, 112 South West Street, Alexandria, VA, 22314, US

(21) Appl. No.: 12/385,109

(22) Filed: Mar. 31, 2009

Related U.S. Application Data
(60) Provisional application No. 61/041,234, filed on Mar. 31, 2008.

(51) Int. Cl. G02B 6/36

(52) U.S. Cl. 385/92

(57) ABSTRACT

A connector attachment to a low height module is described that has a lid configured with an attached spring extension that is substantially planar to the lid. At the end of the spring extension is a spring or compressing mechanism that fits over an external mechanically transferable (MT) ferrule, the ferrule being connected to a ribbon of fibers or communication lines. The external ferrule is fitted to a side of the low height profile module that has an opening to couple the communication lines to the interior/devices in the module. The connector attachment is secured to the module via screws, for example. The combination of the lid with the spring extension and spring/compressing mechanism provides for a very elegant low profile connector assembly that allows communication lines to be more robustly attached to the module than currently practiced and also preserves the overall height of the low height profile module.

### CROSS-REFERENCE TO RELATED APPLICATIONS

This application claims the benefit of U.S. Provisional Patent Application No. 61/041,234, filed Mar. 31, 2008, the contents of which are hereby incorporated by reference in its entirety.

### BACKGROUND

1. Field

The present invention pertains generally to the field of mechanical connectors.

2. Background

Most generally modules are used in data communications. The modules may be located in data centers in a building, airplanes and satellites. The modules may be used for remote sensor read out in box-to-box communications. A module may have an interface that allows connection between itself and another module, or itself and an “interface card” or “interface board” that is integrated in a module or computer. The modules may come in various sizes, and have varying heights. The modules may also be interconnected in a number of ways. Coaxial cables, fiber optic cables, or sometimes free space wireless links may interconnect modules. The interface that allows the interconnection of modules using cables may include connectors to connect the cables. For modules with a height of around fifteen millimeters or more, commercial standard connectors may be used to connect cables and/or ribbons of wires to the modules. When using fiber optic cables or thin wires, the commercial standard connectors come with a jacket that protects the fibers or wires. The jacket has a metal ring that anchors the jacket to the connector. The commercial connector also usually has a strain relief for the jacket. Having the jacket and strain relief for the jacket sometimes makes the connectors as long as the modules themselves.

When fitting multiple boards into a small limited space in the module, the height available for a connector is often below fifteen millimeters. Modules below fifteen millimeters are often called “low profile” modules. For low profile modules, it is not possible to find a commercial standard connector, because the jacket size and strain relief for the jacket have a greater height than that of the height of the module.

Low profile modules, particularly optical modules, are usually connected just using “pigtails”—the fiber cables are exposed and are not protected by any jacket and are “glued” to the module's interface, with the “other” end of the fiber cable fitted with a commercial connector to allow connectability of the module to other systems. The fibers are usually just part of a ribbon of fibers and being only glued to the module often result in being detached when the commercial connector is handled. Also, having a bare fiber or ribbon of fiber cables during assembly or production test increases the chance that the fiber gets damaged. If the fiber is damaged, the whole module has to be discarded because the attached fiber can no longer efficiently couple into the module. Thus, it is desired to find a way to better protect the ribbon of fibers in the connector for low profile modules.

### SUMMARY

The foregoing needs are met, to a great extent, by the present disclosure, which describes in various embodiments a connector attachment for a low height profile module.

In one of various aspects of the disclosure, a connector for a low profile module attachment is provided, comprising: a lid adapted for placement on a low profile module, a spring extension attached to the lid, the spring attachment extending from the lid in a substantially co-planar orientation, wherein the spring extension at a non-attached end of the spring extension contains a spring head that is capable of abutting an external mechanically transferable (MT) ferrule to secure it to a side of the low profile module.

In another one of various aspects of the disclosure, a method for securing an external mechanically transferable (MT) ferrule to a side of the low profile module, is provided, comprising: placing a lid on the low profile module, the lid having a spring extension attached to the lid, the spring attachment extending in a substantially co-planar orientation from the lid, wherein the spring extension at a non-attached end of the spring extension contains a spring head that is capable of abutting a side of the external MT ferrule; and securing the lid to the low profile module by tightening retainers into holes placed in the lid and in the low profile module.

In yet another one of various aspects of the disclosure, a connector for a low profile module attachment is provided, comprising: a means for covering a low profile module, the means for covering having a means for extension attached to the means for covering, the means for extension extending in a substantially co-planar orientation from the means for covering, wherein the means for extension at a non-attached end of the means for extension contains a means for compression that is capable of abutting an external mechanically transferable (MT) ferrule to secure it to a side of the low profile module.

### BRIEF DESCRIPTION OF THE DRAWING

FIG. 1A is an illustration of a low profile module with an exemplary attachment mechanism.

FIG. 1B is an illustration of the embodiment of FIG. 1A without the fiber pigtail.

FIGS. 2A-2B are illustrations showing an assembling sequence for the exemplary embodiment of FIG. 1A.

### DETAILED DESCRIPTION

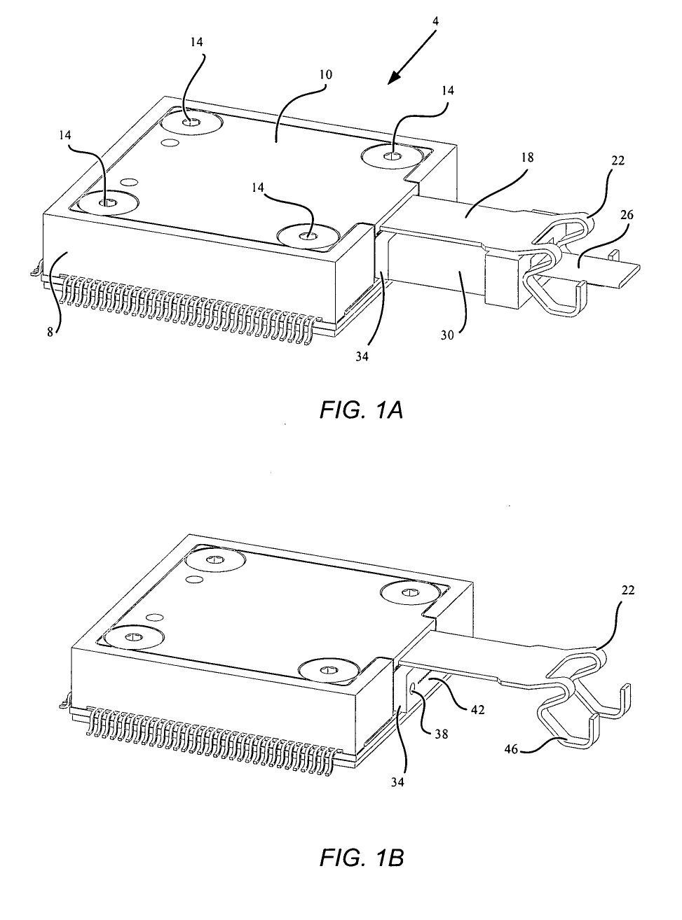

FIG. 1A is an illustration of a low profile module 4 using an exemplary attachment mechanism. A module case 8 having internal circuitry and internal optical fibers (not shown) is capped by module lid 10 which is secured to the module case 8 via screws 14 (or other attachment mechanisms) positioned about the lid 10. Secured to the lid 10 is a spring extension 18 and a spring 22 which are used to attach the optical ribbon of fibers 26 (held by external MT ferrule 30) to the low profile module 4, via “inward’ pressure exerted on the rear of the external MT ferrule 30. The external MT ferrule 30 may be attached to internal MT ferrule 34 in any form suitable for ferrule connection. The configuration of the spring 22 is such that it acts as a clip to secure the external MT ferrule 30 and ensuing fibers 26 to the module 4. Therefore, the use of the external MT ferrule 30 along with spring extension 18 and spring 22 provides an attachment mechanism that avoids direct pressure on the fibers 26.

It should be noted that while the exemplary embodiments herein are discussed in the context of an optical module and/or optical fibers/ribbons, the teachings disclosed herein may be utilized for other types of modules and cables or connection paradigms that require a low profile attachment mechanism. That is, the teachings provided herein may be applied to non-optical systems and/or devices, without departing from the spirit and scope of this disclosure.

FIG. 1B is an illustration of the embodiment shown in FIG. 1A without the fibers 26 and the external MT ferrule 30. Here, the end of internal MT ferrule 34 is visible. Guide holes 38 interior to or on the surface of the internal MT ferrule 34 can be used to guide external MT ferrule 30, for ease of connection as well as for proper orientation, if needed. Internal fibers 42 or connection points are shown that enable signal transference to the fibers 26. Spring 22 may be comprised of one or more spring heads 46, having any one of a variety of shapes that enable the spring 22 to secure the external MT ferrule (not shown) and fibers (not shown) to the module 4. Therefore, the shape and/or design of the heads 46 are not to be limited to the specific shape and/or design shown in FIG. 1B, as other manifestations for a spring head 46 may be used to arrive at the same effect.

In some embodiments, the external ferrule 30 may attach to an optical component (not shown) rather than the module 4. In such an embodiment, the internal MT ferrule 34 may be optional, as according to design preference.

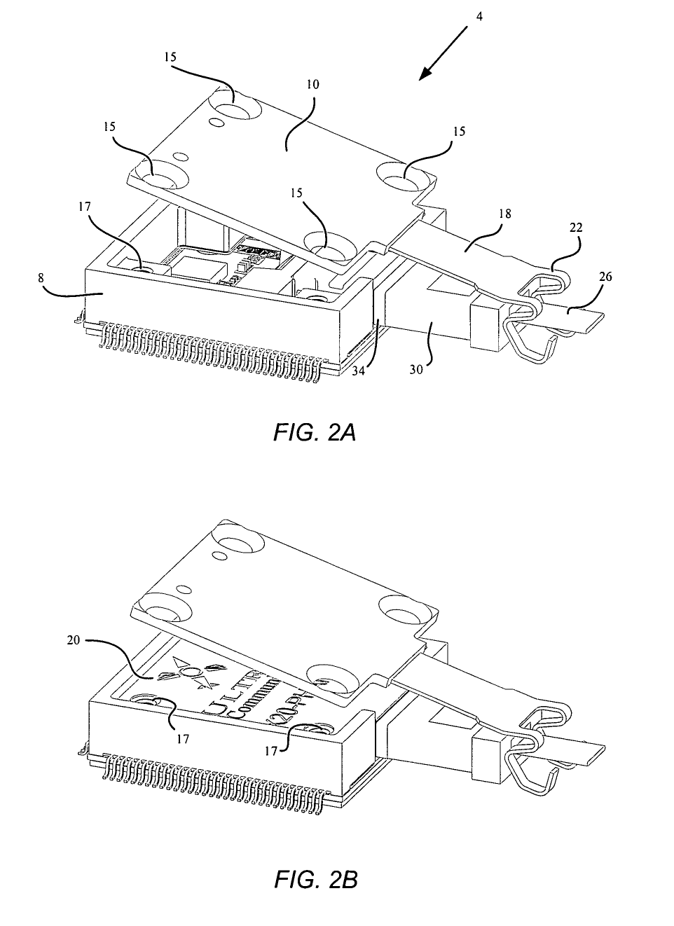

FIG. 2A-2B illustrates the sequence of attaching one external ferrule 30 to the low profile module 4. In FIG. 2A, the module lid 10 is shown elevated off the module case 8, revealing the module case's attachment holes 17. As mentioned above, the mechanism for attachment may be a screw (not shown) via screw/attachment holes 15 in the module lid 10 into the attachment holes 17. In various implementations, it is understood that other forms of attaching or securing the module lid 10 to the module case 8 may be used, without departing from the spirit and scope of this disclosure. For example, a pin or glue (as only two of many possible non-limiting examples) may be used to arrive at the same result. Thus, while the various embodiments shown in disclosure illustrate a screw-like mechanism for attachment, other forms of attachment are understood to be within the purview of this disclosure.

FIG. 2B illustrates a component cover 20 placed inside the module case 8. The component cover 20 can operate to protect the interior components of the low profile module 4 and/or as a heat sink, if desired. Also, in some instances the interior of the module case 8 may not be fitted with attachment holes 15 that match the module lid 10 holes. Therefore, the component cover 20 can also provide the matching attachment holes 17.

Of note in the above FIGS. is that the spring extension 18 is sized to allow the spring 22 to fit over the end of the external MT ferrule 30. In doing so, pressure from the spring 22 can be exerted on the external MT ferrule 30 rather than on the fibers 26, thus avoiding damage to the fibers 26. When the module lid 10 is secured to the module case 8, the configuration of FIG. 1A is arrived at. The spring extension 18 can be fabricated from a standard stock spring connector from US CONEC, part MTA-014, which is a double ended connector having springs 22 on either sides. Here, one end is cut or separated and the severed end is attached to the module lid 10 by means known in the art. The resulting spring mechanism becomes an integral part of the module lid 10 which, when combined with a low profile module 4 (for example, of 5 mm height), allows a total height of the module 4 and exemplary connector to be less than 5 mm.

Several benefits are evident by these exemplary embodiments. First, the low profile height (5 mm) of the exemplary connector allows this connector to be used in many aircraft printed circuit boards, as their module sizes or heights are typically restricted to 5 mm. Because of the configuration shown, the exemplary connector has been shown to keep the MT ferrule/pigtail ribbon assembly mated during thermal cycle ranging from −55° C. to 125° C., as required for Military standard aircraft. Also, the exemplary connector has been shown to keep the MT ferrule/pigtail ribbon assembly mated during aircraft vibrations of up to 30 Gs.

Second, the retention mechanism formed by the lid 10, spring extension 18 and spring 22 is very robust in that it is secured to the module case 8 (or to a firm portion of the module), rather than to the internal MT ferrule 34. Thus, it is resistant to breakage. Third, by the use of screws (presuming an embodiment using screws), no “special” tools other than a screwdriver is needed for securing the connector/external MT ferrule 30. Fourth, the configuration of the spring 22 allows it to be easily removed or placed over the external MT ferrule 30 without damaging it or the fibers 26. Another benefit of the spring 22 is that by “unscrewing” the lid 10, the spring 22 will move in the same plane as the lid 10, thus avoiding twisting of the fibers 26 during attachment or un-attachment. Numerous other advantages can be found, such as, for example, the ability in some embodiments using the spring head 46 configuration shown, to have the applied tension adjusted by appropriate bending of the spring head(s) 46.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A connector for a low profile module attachment comprising:
a lid adapted for placement on a low profile module, a spring extension attached to the lid, the spring attachment extending from the lid in a substantially co-planar orientation, wherein the spring extension at a non-attached end of the spring extension contains a spring head that is capable of abutting an external mechanically transferable (MT) ferrule to secure it to a side of the low profile module.

2. The connector of claim 1, wherein the side of the low profile module contains a module-side MT ferrule adapted to internally fit the external MT ferrule.

3. The connector of claim 1, wherein the external MT ferrule is secured to an optical component inside the low profile module.

4. The connector of claim 1, wherein the lid is substantially square in form.

5. The connector of claim 1, wherein the lid contains a hole for placing a securing mechanism for securing the lid to the low profile module.

6. The connector of claim 1, wherein a width of the spring extension is less than a width of a side of the low profile module.

7. The connector of claim 1, wherein the spring head has an opening that allows a cabling ribbon to pass through when the lid is placed on the low profile module.

8. The connector of claim 1, wherein the lid is substantially circular in form.

9. The connector apparatus of claim 1, wherein the low profile module has a height of 5 mm or less.

10. A method for securing an external mechanically transferable (MT) ferrule to a side of the low profile module, comprising:
placing a lid on the low profile module, the lid having a spring extension attached to the lid, the spring attachment extending from the lid in a substantially co-planar orientation, wherein the spring extension at a non-attached end of the spring extension contains a spring head that is capable of abutting a side of the external MT ferrule; and
securing the lid to the low profile module by tightening retainers into holes placed in the lid and in the low profile module.

11. The method of claim 10, further comprising:
aligning the external MT ferrule with a module-side internal MT ferrule; and
inserting the external MT ferrule into the module-side internal MT ferrule.

12. The method of claim 10, wherein the external MT ferrule is secured to an optical component inside the low profile module.

13. The method of claim 10, wherein a width of the spring extension is less than a width of a side of the low profile module.

14. The method of claim 10, wherein the securing the lid places a cavity in the spring over the cabling ribbon which is attached to the external MT ferrule.

15. The method of claim 10, wherein the low profile module has a height of 5 mm or less.

16. A connector for a low profile module attachment comprising:
a means for covering a low profile module, the means for covering having a means for extension attached to the means for covering, the means for extension extending in a substantially co-planar orientation from the means for covering, wherein the means for extension at a non-attached end of the means for extension contains a means for compression that is capable of abutting an external mechanically transferable (MT) ferrule to secure it to a side of the low profile module.

17. The connector of claim 16, wherein the side of the low profile module contains a module-side MT ferrule adapted to internally fit the external MT ferrule.

18. The connector of claim 16, wherein the external MT ferrule is secured to an optical component inside the low profile module.

19. The connector of claim 16, wherein the means for covering contains a hole for placing a securing mechanism for securing the means for covering to the low profile module.

20. The connector apparatus of claim 16, further comprising a means for attaching the means for covering to the low profile module.
